(19) United States
(12) Patent Application Publication
(10) Pub. No.: US 2018/0322854 A1
(43) Pub. Date: Nov. 8, 2018

(54) Automated Melody Generation for Songwriting

(71) Applicant: WaveAI Inc., Wilmington, DE (US)

(72) Inventors: Margareta Ackerman, Sunnyvale, CA (US); David Loker, Sunnyvale, CA (US); Christopher Cassion, Tampa, FL (US)

(21) Appl. No.: 15/973,970

(22) Filed: May 8, 2018

Related U.S. Application Data
(60) Provisional application No. 62/602,809, filed on May 8, 2017.

(51) Int. Cl. G10H 1/00; G06N 99/00; G06N 5/04

(52) U.S. Cl. CPC G10H 1/0025; G06N 99/005; G10H 2210/071; G10H 2210/111; G10H 2210/066; G06N 5/04

(57) ABSTRACT

The subject disclosure relates to automated songwriting. In some aspects, a process of the disclosed technology can include steps for training a melody prediction model for selecting melodies for lyrics using a corpus of songs, the melody prediction model including modeled melody features and corresponding modeled patterns of lyric features, receiving lyric input of lyrics including a pattern of lyric features from a user, applying the melody prediction model to the lyric input to automatically generate one or more melodies for the lyric input by matching the pattern of lyric features in the lyric input to a first subset of the modeled melody features using the corresponding modeled patterns of lyric features of the modeled melody features, and providing the one or more melodies to the user to generate a song using the lyrics.

### PRIORITY

The present application claims the priority benefit of U.S. provisional patent application No. 62,602809 filed May 8, 2017, the disclosure of which is incorporated herein by reference.

### BACKGROUND

### 1. Technical Field

Aspects of the subject technology relate to automated songwriting, and in particular, to a platform for facilitating automated generation of melodies for songs based on lyrics.

### 2. Description of the Related Art

Songwriting is a difficult task that utilizes skills in different areas. Specifically, songwriting requires skills in both writing lyrics and writing music or melodies for the lyrics. This is illustrated by the fact that often times many individuals with different skills contribute to different aspects of writing songs. For example, often times a singer in a band writes lyrics for a song while musical instrument players in the band write the melodies for the song. Additionally, often times an individual has to be capable of reading music in order to write melodies for songs. This makes it difficult for a single individual to write both lyrics and melodies for a song. There therefore exist needs for systems and methods that facilitate automated songwriting for people.

Current automated songwriting systems and methods are rule-based and utilize Markov chains for providing automated songwriting. Rule-based systems have a number of deficiencies in performing automated songwriting. Using rule-based systems for automated songwriting can lead to a lack of genre flexibility. Specifically, rule-based systems lack the ability to learn a new style from a corpus. More specifically, rule-based systems lack the ability to learn across different styles from different corpuses, e.g. both classic rock music and modern rock music. In turn, this makes it difficult to use a rule-based system utilizing Markov chains to perform automatic songwriting for different genres of songs, e.g. classical music and pop music. There therefore exist needs for non-rule-based systems and methods for automated songwriting, in particular to provide flexibility across different music genres for automated songwriting.

Another deficiency of current rule-based automated songwriting systems is that Markov chains used in the rule-based systems attempt to mimic musical components of songs, while ignoring actual lyrics used in writing songs. This is critical as lyrics and languages used to sing the lyrics greatly influence quality of melodies for songs. In particular, lyrics and languages used to sing the lyrics greatly influence quality of melodies across different genres of music. For example, melody quality in songs with lyrics sung in the English language is heavily dependent on vowels in lyrics of the songs. In another example, melody quality in opera is heavily dependent on lyrics as all singers are assumed to sing in the same style. There therefore exist needs for systems and methods for automated songwriting that account for lyrics and/or languages of the lyrics.

Further, current rule-based songwriting systems fail to provide an internal system for checking on quality of generated melodies and songs. For example, current rule-based songwriting systems tend to generate melodies that sound the same as previously created melodies. In turn this can lead to a lack of variety amongst songs generated current rule-based songwriting systems. There therefore exist needs for systems and methods for automated songwriting that internally monitors quality of generated melodies and songs.

Additionally, current rule-based songwriting systems function nearly autonomously from users. More specifically, current rule-based songwriting systems fail to provide mechanisms that allow users to actively collaborate with the systems and affect the output created by such systems. This is problematic as users cannot customize automated songwriting according to their own personal preferences. Further, this is problematic as it can lead to greater uniformity of automated songwriting across different users when less uniformity across the different users is actually desired. There therefore exist needs for systems and methods for automated songwriting that allow for greater amounts of user collaboration in the automated songwriting process.

### SUMMARY OF THE CLAIMED INVENTION

The presently claimed invention relates to a method, a non-transitory computer readable storage medium, or an apparatus executing functions consistent with the present disclosure for automatically generating melodies as part of automated songwriting. A method consistent with the present disclosure can include training a melody prediction model for selecting melodies for lyrics using a corpus of songs. The melody prediction model can include modeled melody features and corresponding modeled lyric features. The method can include receiving lyric input of lyrics including lyric features from a user. Subsequently, the method can apply the melody prediction model to the lyric input to automatically generate one or more melodies for the lyric input by generating probability distributions of melody features based on the lyric features in the lyrics input using the melody prediction model and selecting melody features from the probability distributions of melody features to form the one or more melodies. The method can include providing the one or more melodies to the user to generate a song using the lyrics.

When the presently claimed invention is implemented as a system, one or more processors executing instructions embodied in a computer readable storage medium can execute the instructions to train a melody prediction model for selecting melodies for lyrics using a corpus of songs. The melody prediction model can include modeled melody features and corresponding modeled lyric features. The one or more processors can execute the instructions to receive lyric input of lyrics including lyric features from a user. Subsequently, the one or more processors can execute the instructions to apply the melody prediction model to the lyric input to automatically generate one or more melodies for the lyric input by generating probability distributions of melody features based on the lyric features in the lyrics input using the melody prediction model and selecting melody features from the probability distributions of melody features to form the one or more melodies. Further, the one or more processors can execute the instructions to provide the one or more melodies to the user to generate a song using the lyrics.

When the presently claimed invention is implemented as a non-transitory computer readable storage medium, one or more processors executing a program embodied in the computer readable storage medium can execute the program to train a melody prediction model for selecting melodies for lyrics using a corpus of songs. The melody prediction model can include modeled melody features and corresponding modeled lyric features. The one or more processors can execute the program to receive lyric input of lyrics including lyric features from a user. Subsequently, the one or more processors can execute the program to apply the melody prediction model to the lyric input to automatically generate one or more melodies for the lyric input by generating probability distributions of melody features based on the lyric features in the lyrics input using the melody prediction model and selecting melody features from the probability distributions of melody features to form the one or more melodies. Further, the one or more processors can execute the program to provide the one or more melodies to the user to generate a song using the lyrics.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example of environment in which some aspects of the technology can be implemented.

FIG. 2 illustrates steps of an example process for automatically generating a melody for a song based on lyrics as part of automated songwriting.

FIG. 3 illustrates an example of an environment for automatically generating tuned melodies based on lyrics.

FIG. 4 illustrates steps of an example process for automatically generating tuned melodies for a song based on lyrics.

FIG. 5 illustrates an example of a system for internally evaluating melodies automatically generated based on lyrics.

FIG. 6 illustrates steps of an example process for assigning internal quality scores to melodies automatically generated based on lyrics.

FIG. 7 illustrates a computing system that may be used to implement an embodiment of the present invention.

### DETAILED DESCRIPTION

The detailed description set forth below is intended as a description of various configurations of the subject technology and is not intended to represent the only configurations in which the technology can be practiced. The appended drawings are incorporated herein and constitute a part of the detailed description. The detailed description includes specific details for the purpose of providing a more thorough understanding of the technology. However, it will be clear and apparent that the technology is not limited to the specific details set forth herein and may be practiced without these details. In some instances, structures and components are shown in block diagram form in order to avoid obscuring the concepts of the subject technology.

Songwriting is a difficult task that utilizes skills in different realms. Specifically, songwriting requires skills in both writing lyrics and writing music or melodies for the lyrics. This is illustrated by the fact that often times many individuals with different skills contribute to different aspects of writing songs. For example, often times a singer in a band writes lyrics for a song while musical instrument players in the band write the melodies for the song. Additionally, often times an individual has to be capable of reading music in order to write melodies for songs. This makes it difficult for a single individual to write both lyrics and melodies for a song. There therefore exist needs for systems and methods that facilitate automated songwriting for people.

Current automated songwriting systems and methods are rule-based and utilize Markov chains for providing automated songwriting. Rule-based systems have a number of deficiencies in performing automated songwriting. In particular, using rule-based systems for automated songwriting can lead to a lack of genre flexibility. Specifically, rule-based systems lack the ability to learn a new style from a corpus. More specifically, rule-based systems lack the ability to learn across different styles from different corpuses, e.g. both classic rock music and modern rock music. In turn, this makes it difficult to use a rule-based system utilizing Markov chains to perform automatic songwriting for different genres of songs, e.g. classical music and pop music. There therefore exist needs for non-rule-based systems and methods for automated songwriting, in particular to provide flexibility across different music genres for automated songwriting.

Another deficiency of current rule-based automated songwriting systems is that Markov chains used in the rule-based systems attempt to mimic musical components of songs, while ignoring actual lyrics used in writing songs. This is critical as lyrics and languages used to sing the lyrics greatly influence quality of melodies for songs. In particular, lyrics and languages used to sing the lyrics greatly influence quality of melodies across different genres of music. For example, melody quality in songs with lyrics sung in the English language is heavily dependent on vowels in lyrics of the songs. In another example, melody quality in opera is heavily dependent on lyrics as all singers are assumed to sing in the same style. There therefore exist needs for systems and methods for automated songwriting that account for lyrics and/or languages of the lyrics.

Further, current rule-based songwriting systems fail to provide an internal system for checking on quality of generated melodies and songs. For example, current rule-based songwriting systems tend to generate melodies that sound the same as previously created melodies. In turn this can lead to a lack of variety amongst songs generated using current rule-based songwriting systems. There therefore exist needs for systems and methods for automated songwriting that internally monitors quality of generated melodies and songs.

Additionally, current rule-based songwriting systems function nearly autonomously from users. More specifically, current rule-based songwriting systems fail to provide mechanisms that allow users to actively collaborate with the systems. This is problematic as users cannot customize automated songwriting according to their own personal preferences. Further, this is problematic as it can lead to greater uniformity of automated songwriting across different users when less uniformity across the different users is actually desired. There therefore exist needs for systems and methods for automated songwriting that allow for greater amounts of user collaboration in the automated songwriting process.

The subject technology addresses the foregoing limitations by providing a system for automatically generating melodies based on lyrics as part of automated songwriting.

By way of example, a melody prediction model for selecting melodies for lyrics can be trained using a corpus of songs. The melody prediction model can include modeled melody features and corresponding modeled lyric features. Further, by way of example, lyric input of lyrics including lyric features can be received from a user. Subsequently, by way of example, the melody prediction model can be applied to the lyric input to automatically generate one or more melodies for the lyric input by generating probability distributions of melody features based on the lyric features in the lyrics input using the melody prediction model and selecting melody features from the probability distributions of melody features to form the one or more melodies. By way of example, the one or more melodies can be provided to the user to generate a song using the lyrics.

In some aspects, input indicating values of one or more tunable melody creation parameters for customizing automatic generation of a melody can be received from a user. A melody prediction model can be applied to lyric input according to the values of the one or more tunable melody creation parameters to automatically generate one or more melodies based on the lyric input for the user in a customized fashion for the user.

In some aspects, corresponding internal quality scores can be assigned to a plurality of melodies created by applying a melody prediction model to lyric input. The internal quality scores can be assigned to the plurality of melodies based on both a sequence likelihood of corresponding sequences of notes of the plurality of melodies and an amount of note entropy across notes in the corresponding sequences of notes of the plurality of melodies. The plurality of melodies can be reproduced to a user based on the corresponding internal quality scores assigned to the plurality of melodies.

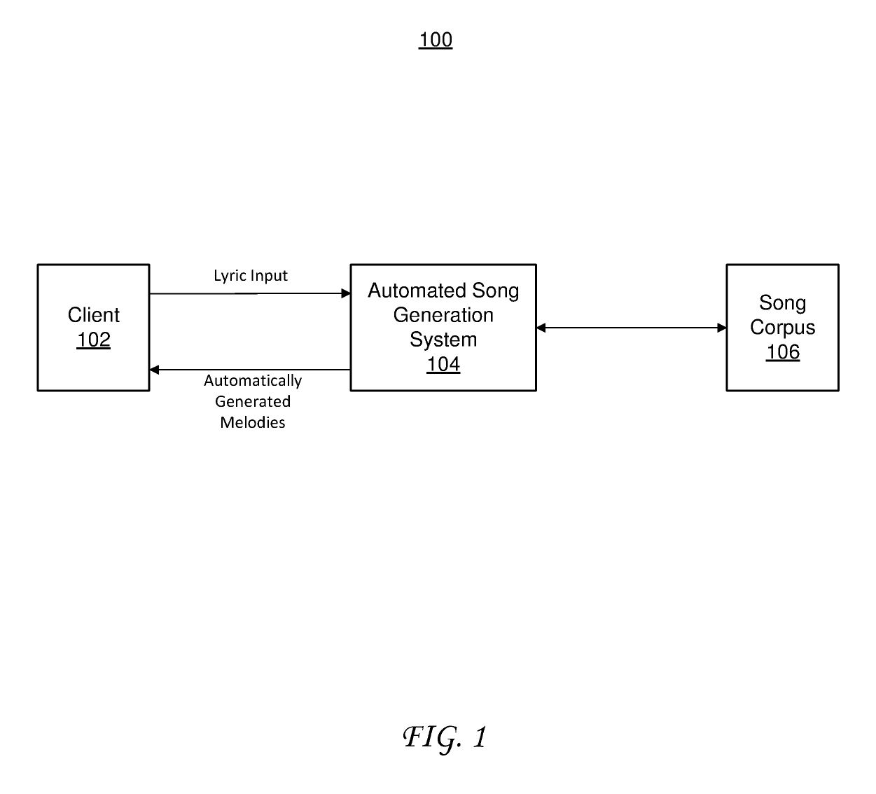

FIG. 1 illustrates an example of environment 100 in which some aspects of the technology can be implemented. The example environment 100 includes a client 102, an automated song generation system 104, and a song corpus 106. The client 102 can be utilized by a user to communicate with the automated song generation system 104 for purposes of generating a song. More specifically, the client 102 can be utilized by a user to communicate with the automated song generation system 104 to generate a song through an automated manner based on specific lyrics. For example, the client 102 can provide lyric input for purposes of generating a song based on the lyric input. In return, the client 102 can receive data for reproducing melodies generated automatically based on the lyric input and capable of being used in subsequently generating a song. The automated song generation system 104 can be implemented, at least in part, at the client 102. For example, the automated song generation system 104 can be implemented, in part, as a web portal accessed through a browser executing at the client 102. Further, the automated song generation system 104 can be implemented, at least in part, as a native application executing at the client 102.

The automated song generation system 104 functions to automatically generate melodies for automated song generation based on lyrics. Subsequently, melodies automatically generated based on the lyrics can be used to construct a song in an automated fashion. This is advantageous to individuals who lack the expertise to generate melodies as part of songwriting. In particular, individuals who are unable to read or compose music can utilize the automated song generation system 104 to build songs through automated song generation.

The automated song generation system 104 can train a melody prediction model for use in automatically generating melodies based on lyrics. Specifically, the automated song generation system 104 can train a melody prediction model from the song corpus 106. The song corpus 106 includes a repository of all or portions of songs that can be used to train a melody prediction model. Specifically, the song corpus 106 can include music files with a single instrument corresponding to a vocal line and accompanying lyrics. Accordingly, each note in songs in the song corpus 106 can have a corresponding syllable. The song corpus 106 can include songs stored in an applicable data format for representing songs in a form capable of training a model. Specifically, the songs can be stored in an applicable data format for representing songs in musical notation. For example, the song corpus 106 can store songs in music extensible markup language (herein referred to as “MXL”) files.

Songs included in the song corpus 106 can be specific to a type or genre of music. For example, songs included in the song corpus 106 can be limited to classic rock songs. As the song corpus 106 can be limited to a specific type or genre of music, the automated song generation system 104 can train a melody prediction model that is explicit to the specific type or genre of music. Further, as will be discussed in greater detail later, the automated song generation system 104 can create models that are prediction models implementing corpus-based, probabilistic generative models instead of rule-based models or using Markov chains, as is typically used by automated songwriting systems. This is advantageous, as it can help to ensure that the prediction models are tailored to different genres of music, as opposed to rule-based models that are generic across different genres of music.

The automated song generation system 104 can create melody prediction models that are unique and different across genres of music using corpuses that each include songs of a specific genre of music. For example, the automated song generation system 104 can create a melody prediction model for classical music using a song corpus that only includes classical songs and create another melody prediction model for modern popular music using a song corpus that only includes modern popular music songs. This can allow a user to select a specific genre of music and create songs that are tailored to the specific genre of music through a melody prediction model created for the specific genre of music.

Further, the automated song generation system 104 can train a melody prediction model based on features of music included in the song corpus 106. Specifically, the automated song generation system 104 can train a melody prediction model using both melody features, and lyric features of songs in the song corpus 106. More specifically, the automated song generation system 104 can train a melody prediction model to learn the relationships between melody features and corresponding lyric features of songs in the song corpus to create modeled melody features and corresponding modeled lyrics features. Creating a melody prediction model based on both melody features and lyric features can solve the previously described deficiencies of current automated songwriting systems that only train models without considering lyric features of songs.

In training a melody prediction model based on features of songs included in the song corpus 106, the automated song generation system 104 can identify or otherwise extract melody features from the songs in the song corpus 106. Melody features can include applicable features that define melodies in songs, e.g. on either or both a note by note basis or a combination of notes basis. For example, melody features can include: whether a note is in a first measure, e.g. a Boolean variable indicating whether or not a note belongs to a first measure of a song; key and time signatures; offset, e.g. the number of beats from the start of a song; offset within measure, e.g. the number of beats from the start of a measure; duration, e.g. the length of a note; scale degree, e.g. the scale degree of a note (1-7); accidental, e.g. the accidental of a note (flat, sharp, or none); beat strength, e.g. the strength of beat as defined by music21 and/or the continuous and categorical version (beat strength factor) of this variable; offbeat, e.g. a Boolean variable specifying whether or not a note is offbeat; information of notes in relation to each other, e.g. the scale degree, the accidental, and the duration of a specific number of previous notes; octave, e.g. an octave to which the current and the previous five notes belong and the octave expressing in a range (3-6); information of a last note in a melody, e.g. whether a note is the last note of the phrase or melody corresponding to the final syllable in a lyrical phrase; and a previous notes' step different, e.g. an interval size from one note to the next for a specific number of previous notes.

Further, in training a melody prediction mode based on features of songs included in the song corpus 106, the automated song generation system 104 can identify or otherwise extract lyric features from the songs in the song corpus 106. Lyric features can include applicable features that define lyrics used in songs, e.g. on one or a combination of a vowel basis, a consonant basis, a syllable basis, and a word basis. For example, lyric features can include: syllable type, e.g. whether a syllable in one of a single (whether a word consists of a single syllable), begin (whether a syllable is the first syllable in a word), middle (whether a syllable occurs in the middle of a word), and end (whether a syllable is the last syllable in a word); syllable number, e.g. a number of syllable in a word, word frequency, e.g. a word frequency of a word including a specific syllable; word vowel strength, e.g. a strength of a word based on vowels included in the word, primary, secondary, or none; and a number of vowels in a word.

The automated song generation system 104 can extract features using a language model. Specifically, the automated song generation system 104 can use a language model to extract melody features of lyrics of songs in the song corpus 106. Further, the automated song generation system 104 can use a language model to extract lyric features of lyrics of songs in the song corpus 106. A language model used by the automated song generation system 104 can include mappings of words and phrases to corresponding pronunciations or utterances of the words of phrases. Further, a language model can be particular to either or both a specific type of language and a specific dialect of a language. For example, the automated song generation system 104 can utilize a language model for American English to extract features for building a melody prediction model. In utilizing a language model specific to a language or a dialect of a language, the automated song generation system 104 can generate melodies that are tailored for a specific language or dialect. Specifically, certain melodies are appropriate for certain text in certain languages based on alignment in emphasis and syllable strength of the text in the certain languages. In turn, by building a melody prediction model using a language model for the specific language, the automated song generation system 104 can help to ensure that more pleasing melodies are automatically generated for songs sung in the specific language.

In using extracted features to build a melody prediction model, the automated song generation system 104 can combine features extracted from songs in the song corpus 106 to form patterns of melody features and patterns of lyric features in a melody prediction model. Further, the automated song generation system 104 can combine features to probabilistically associate melody features with lyric features in a melody prediction model to create modeled melody features and lyric features. More specifically, in combining features to probabilistically associate melody features with lyric features, the automated song generation system 104 can extract general principals about songwriting, as indicated by the probabilistic associations between melody features and lyric features. Accordingly, the automated song generation system 104 can generate new melodies based on these general principals of songwriting learned through probabilistic association of lyric features and melody features.

The automated song generation system 104 can combine features extracted from songs in the song corpus 106 using an applicable non-linear learning mechanism. For example, the automated song generation system 104 can combine features extracted from songs in the song corpus 106 through either or both random forests and neural networks in order to train a melody prediction model. Using random forests to train a melody prediction model is advantageous as random forests are well-suited for large numbers of categorical variables. Further, using random forests and neural networks to train a melody prediction model is advantageous as they can allow for non-linearity in combining features. In turn this can help in avoiding over-fitting, due in part to the large amount of data used to train a melody prediction model.

Further, in combining features extracted from the songs, the automated song generation system 104 can split portions of data for a total number of extracted features to create a subset of data and a corresponding subset of extracted features. For example, the automated song generation system 104 can use stratified sampling to split a total number of extracted features into a training set of extracted features, e.g. 75% of the total number of extracted features. Subsequently, the automated song generation system 104 can use the subset of data and the corresponding subset of extracted features to train a melody prediction model through feature combination. Data and corresponding features split from the original data of the extracted features which are not used to train a prediction model can be used for further testing or evaluation of the model.

In various embodiments, the automated song generation system 104 can split portions of data from an original data set before features are extracted. More specifically, the automated song generation system 104 can split data of songs in the song corpus 106 to create a portion of the total data in the song corpus 106, and then extract features from the portion of the total data in the song corpus 106. For example, the automated song generation system 104 can split, e.g. using stratified sampling, 75% of the total data in the song corpus to train a melody prediction model. Subsequently, the automated song generation system 104 can use the remaining 25% of the total data to evaluate the melody prediction model.

A melody prediction model created by the automated song generation system 104 can include a combination of separate and distinct models. For example, a melody prediction model created by the automated song generation system 104 can include a combination of an octave model with octave modeled features and corresponding modeled lyric features, a pitch model with modeled pitch features and corresponding modeled lyric features, and a rhythm model with modeled rhythm features and corresponding modeled lyric features. An octave model can include octave-specific melody features probabilistically associated with corresponding lyric features. In melody prediction model application, the automated song generation system 104 can use an octave model to predict an octave in which each note is positioned in an automatically generated melody. A rhythm model can include rhythm-specific melody features probabilistically associated with corresponding lyric features. In melody prediction model application, the automated song generation system 104 can use a rhythm model to predict note duration of notes in an automatically generated melody. A pitch model can include pitch-specific melody features probabilistically associated with corresponding lyric features. In melody prediction model application, the automated song generation system 104 can use a pitch model to predict a scale degree of a note, potentially with possible accidentals.

Further, a melody prediction model created by the automated song generation system 104 can include an interval model. More specifically, a melody prediction model can include an interval model instead of an octave model and a melody model. An interval model can include melody features and corresponding lyric features that are used to predict intervals between consecutive notes. An interval model included as part of a melody prediction model can be applied with a rhythm model included as part of the melody prediction model to generate one or more melodies.

Multiple models included as part of a melody prediction model can be created by the automated song generation system 104 by sorting melody features to form melody feature patterns as part of training the multiple models. Specifically, melody features can be sorted based on feature types of the melody features and subsequently be used to train the multiple models based on the sorting of the melody features. For example, melody features can be sorted using an outcome variable of scale degree with accents through stratified sampling. Further in the example, a pitch model of a melody prediction model can be trained based on the sorting of the melody features using scale degree with accents. In another example, melody features can be sorted using an outcome variable of note duration through stratified sampling. Subsequently, a rhythm model of a melody prediction model can be trained based on the sorting of the melody features through note duration.

The automated song generation system 104 can receive lyric input for lyrics from the client 102. Based on the lyric input received from the client 102, the automated song generation system 104 can automatically generate one or more melodies that can subsequently be utilized by a user to generate a song in an automated fashion based on lyrics of the corresponding lyric input. Lyric input used in automated melody building can include data indicating desired lyrics, e.g. of a user. For example, lyric input can indicate a phrase a user wants to say in a lyric for a song. Further, lyric input used in automatically building melodies can include or be used to construct a pattern of lyric features for corresponding lyrics in the lyric input. Specifically, lyric features, forming a pattern of lyric features for lyric input, can include one of the previously described lyric features used by the automated song generation system 104 to train a melody prediction model. For example, lyric features for lyric input can include word vowel strengths of words included lyric input received from a user.

In automatically generating melodies based on lyric input, the automated song generation system 104 can identify lyric features and patterns of lyric features to form feature sets of lyrics in the lyric input. Feature sets of lyrics can be formed using specific amounts of lyric input, e.g. on a line by line basis, a phrase by phrase basis, or a verse by verse basis. For example, the automated song generation system 104 can analyze a line in lyrics provided by the lyric input to extract lyric features and patterns of lyric features forming a feature set for the line. The automated song generation system 104 can then use a feature set including identified lyric features and patterns of lyric features to automatically generate a melody based on the feature set.

The melody prediction model is a probabilistic model and it can be applied by the automated song generation system 104 to lyric input to generate one or more probability distributions over possible outcomes. Specifically, the melody prediction model can be applied to lyric input to generate a probability distribution, e.g. one for each note, and subsequently a melody feature can be selected from the probability distribution to identify one or more melody features corresponding to each note in an automatically generated song. For example, the automated song generation system 104 can create a probability distribution summing to 1 over all possible note outcomes (e.g. a quarter note with pitch C4, or a sixteenth note with pitch G#5). Subsequently, a note is selected from the possible note outcomes based upon the probability distribution based upon lyrics and features derived from the lyrics and the context of the current note. This can continue on a note by note basis until an entire melody or portion of a melody is generated.

The melody prediction model can be updated and/or applied according to melody features of previously selected notes for generated melodies. For example, the melody prediction model can be updated and/or applied according to melodies automatically generated and selected by a user for a given portion of lyrics, e.g. a line of lyrics. The automated song generation system 104 can generate a probability distribution as a function of lyric features of lyrics provided by a user, a current context for a note including notes of a previously selected melody by the user and notes generated for a current section of lyrics, e.g. a lyric line, and composition features. Composition features can include current features derived from a composition at its current place, e.g. key signature and tempos. Subsequently, lyric features for a current note can be selected from the probability distribution. The automated song generation system 104 can then move onto the next note and generate a new probability distribution/update the probability distribution in the same fashion, including updating based on the just described previously created note. The automated song generation system 104 can then select new lyric features for the next note from the updated probability distribution. This process can continue until an entire melody is generated for given lyric input.

In using probability distributions and probabilistic associations between lyric features and melody features, the automated song generation system can cure the deficiencies of the previously described rule-based systems for automated song generation. Specifically, this helps to ensure that rules are not created, e.g. within a melody prediction model, which explicitly associate specific words or lyrics with specific melodies or portions of melodies. In turn, this provides for flexibility across genres of music as lyrics are not automatically mapped to specific melodies based on rules, regardless of a music genre of a generated song. Further, this ensures that models trained with music from different genres are actually different models lacking shared rules across genres, thereby allowing for automatic tailoring of different models to different genres of music.

The automated song generation system 104 can apply a plurality of models forming a melody prediction model to automatically generate one or more melodies for a feature set from lyric input. Specifically, the automated song generation system 104 can apply a combination of an octave model, a rhythm model, and a pitch model to a feature set to generate one or more melodies for lyric input. For example, the automated song generation system 104 can apply an octave model to a feature set of lyric input to identify octaves for notes in melodies generated for the lyric input. Further in the example, the automated song generation system 104 can apply a rhythm model to identify note durations of the notes in the melodies generated for the lyric input. Still further in the example, the automated song generation system 104 can apply a pitch model to identify scale degrees of the notes in the melodies generated for the lyric input. The automated song generation system 104 can apply models forming a melody prediction model to a feature set on a note by note basis. For example, the automated song generation system 104 can identify an octave of each note in a melody and identify note duration of each note in the melody through application of corresponding octave and rhythm models forming a melody prediction model.

In applying a plurality of models forming a melody prediction model to automatically generate one or more melodies for a feature set, the automated song generation system 104 can apply the plurality of model in a specific sequential order. For example, the automated song generation system 104 can first apply an octave model to a feature set, then a rhythm model to the feature set, and finally a pitch model to the feature set. In applying models in a sequential order, the automated song generation system 104 can apply each subsequent model based on application of one or a combination of previously applied models. For example, the automated song generation system 104 can apply an octave model to identify an octave for a note in an automatically generated melody. Subsequently, the automated song generation system 104 can apply a rhythm model to identify a length of the note based on the octave identified through application of the octave model.

After automatically generating one or more melodies for the lyric input the automated song generation system 104 can provide the one or more melodies to the client 102. Specifically, the automated song generation system 104 can reproduce the one or more melodies to the user through the client 102. When multiple melodies are generated for the lyric input, the automated song generation system 104 can reproduce the melodies for the user in an order. For example, the automated song generation system 104 can reproduce the melodies for the user in a random order through the client 102. Alternatively, the automated song generation system 104 can reproduce the melodies for the user in a specific order through the client 102, e.g. based on corresponding internal quality scores, as will be discussed in greater detail later, assigned to the melodies. The user can then pick one of the melodies and all or a portion of the song can be created using the selected melody. The composition can then be produced, which may include recording one or more vocal melodies.

The automated song generation system 104 can generate one or more melodies for additional lyric input received from the client 102. Specifically, once the automated song generation system 104 automatically generates one or more melodies for lyric input or once a user accepts a melody generated for lyric input, then the automated song generation system 104 can generate one or more melodies for additional lyric input received from the client 102. The additional lyric input can be received at the same time the original lyric input is received at the automated song generation system 104 from the client 102. For example, the additional lyric input can include a second line in a verse of lyrics received from the client 102 at the same time as a first line in the verse as part of lyric input. After generating melodies for the additional lyric input, the automated song generation system 104 can reproduce the melodies for the user through the client 102. The user can then select or otherwise accept one of the melodies. Subsequently, the selected melody can be stitched together or otherwise combined with the previously selected melody to build a single melody for the song. This process can repeat itself for given lyrics in a song until the entire melody is created for the song. This allows a user to automatically build an entire melody for a song based on lyrics, even if the user lacks the skills necessary to write melodies, e.g. the user lacks the ability to read music.

Further, in automatically generating a song, the automated song generation system 104 can select chords for the song. Specifically, as chords are directly based on melodies, the automated song generation system 104 can select chords for a song based on automatically generated melodies for a song. The automated song generation system 104 can then generate the song based on the chords selected using the automatically generated melodies for the song. Additionally, the automated song generation system 104 can transmit selected chords to the client 102 where they can be reproduced for the user. The user can then approve or deny the chords and the automated song generation system 104 can generate the song using the chords based on whether the user accepts or denies the chords, offering alternative chords that the user can again choose to approve or deny.

Additionally, in automatically generate a song, the automated song generation system 104 can select one or more drum beats for a song. Specifically, the automated song generation system 104 can randomly select drum beats provided by a third party system. The automated song generation system 104 can then generate the song based on the one or more drum beats randomly selected for the song. Additionally, the automated song generation system 104 can transmit selected drum beats to the client 102 where they can be reproduced for the user. The user can then approve or deny the drum beats and the automated song generation system 104 can generate the song using the drum beats based on whether the user accepts or denies the drum beats.

In various embodiments, the automated song generation system 104 can generate a melody for lyrics based on both given lyrics and a previously generated melody. More specifically, the automated song generation system 104 can automatically generate a melody for a line of lyrics based on both the line of lyrics and one or more generated melodies for a previous line of lyrics. In turn, this allows a user to create new melodies that are of varying degrees of similarity to a previously created, e.g. user specified, melody. Further, this allows for more fluid transition and easier connection between melodies separately generated for phrases connected together in lyrics.

The automated song generation system 104 can generate a melody based on a previously generated melody using characteristics of the previously generated melody. In particular, the automated song generation system 104 can input the last n notes, e.g. user specified n notes. As a result, the beginning of the melody can be generated based on the last n notes of the previous melody. Specifically, as discussed previously, the last n notes of a previous melody can be incorporated into the melody prediction model, e.g. as the current context, and subsequently be used to generate probability distributions. In turn, lyric features can be selected from these probability distributions on a note by note basis to automatically generate the melody, at least in part, based on the previous melody.

In various embodiments, a song automatically created using the automated song generation system 104 can be added to the song corpus 106. The automated song generation system 104 can then further train or re-train the melody prediction model based, at least in part, on the new song added to the song corpus 106. By updating the melody prediction model based on newly added songs to the song corpus 106, the automated song generation system 104 can help to ensure that varying melodies or styles of melodies are generated through application of the model.

In various embodiments, the automated song generation system 104 can take into account a user's selection of melodies in forming new melodies for the user, e.g. in different songs created by the user. Specifically, a song created for the user can be used to train the melody prediction model for use in generating future songs. Alternatively, the automated song generation system 104 can apply a previously created melody for a user, e.g. in a previously created song, when applying the melody prediction model to generate probability distributions. In turn, notes in a current melody can be selected from the probability distributions, effectively, selecting the notes, at least in part, based on the previously created melody. This can further ensure, that the automated song generation system is not functioning as a completely autonomous system, but is instead acting as a co-creative system with the user unlike current automated songwriting systems.

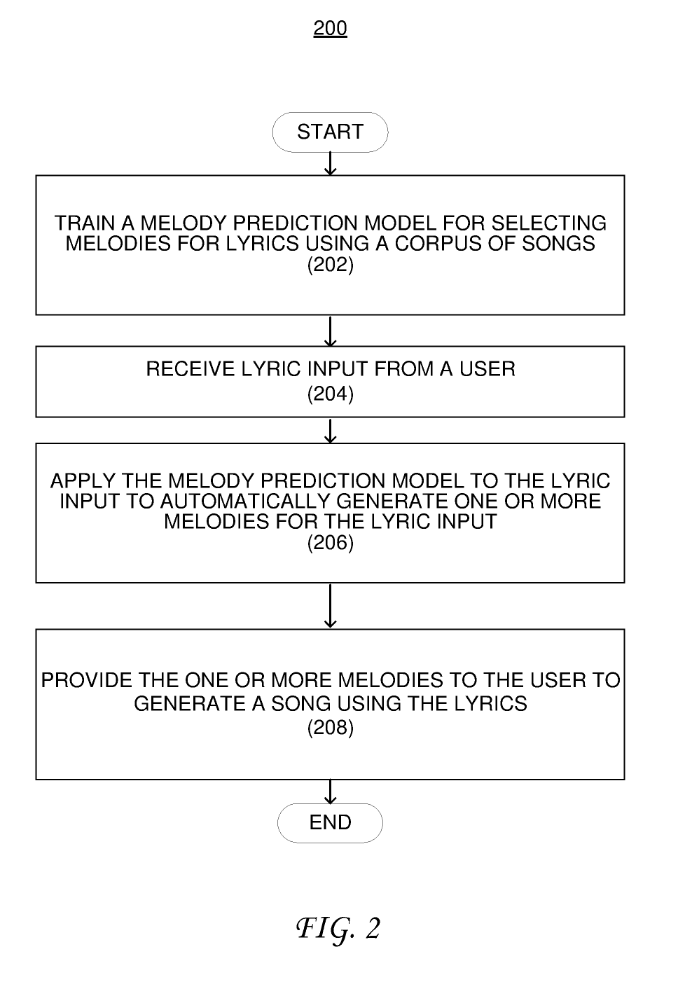

FIG. 2 illustrates steps of an example process 200 for automatically generating a melody for a song based on lyrics as part of automated songwriting. The process 200 begins at step 202, where a melody prediction model for selecting melodies for lyrics is trained using a corpus of songs. The melody prediction model can be trained at step 202 using the various techniques and systems described herein. For example, the melody prediction model can be trained using extracted features from songs in the corpus of songs by combining the extracted features using a non-linear learning mechanism.

At step 204, lyric input is received from a user. The lyric input can include lyrics forming a pattern of lyric features. More specifically, lyric features can be identified from lyrics included in the lyric input. The lyric features can correspond to lines in the lyrics included in the lyrics input.

At step 206, the melody prediction model is applied to the lyric input to automatically generate one or more melodies for the lyric input. The melody prediction model applied to the lyric input, as described herein, can include multiple models. For example, the melody prediction model applied to the lyric input can include an octave model, a rhythm model, and a pitch model. Further, the different models making up the melody prediction model can be applied to the lyric input in a specific order. For example, the octave model can first be applied to the lyric input, followed by the rhythm model, and finally the pitch model.

At step 208, the one or more melodies are provided to the user for generating a song using the lyrics and the one or more melodies. Specifically, the one or more melodies can be reproduced for the user, and the user can select a melody from the one or more melodies to use in building an overall melody for a song based on the lyrics. The one or more melodies can be reproduced for the user in a specific order. For example, the one or more melodies can be reproduced for the user in an order based on internal quality scores assigned to the one or more melodies.

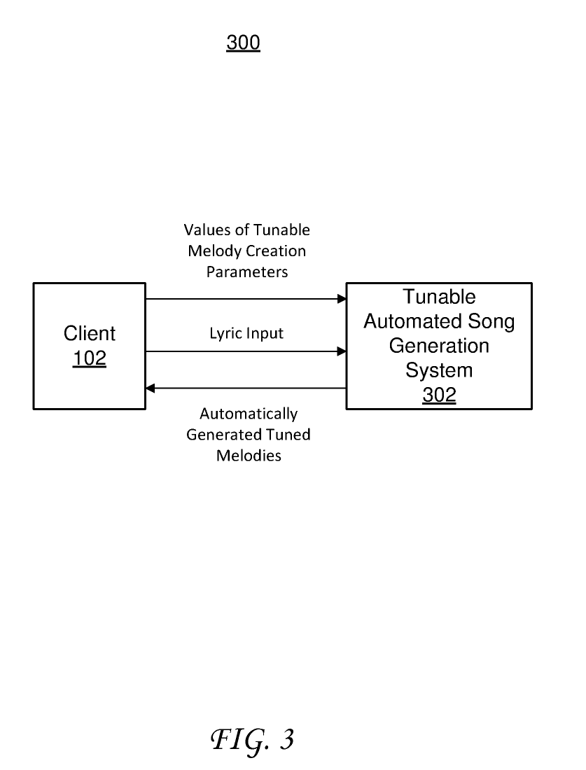

FIG. 3 illustrates an example of an environment 300 for automatically generating tuned melodies based on lyrics. The example environment 300 includes a client 102 and a tunable automated song generation system 302. The tunable automated song generation system 302 can function according to the automated song generation system 104 for purposes of automatically generating melodies based on lyric input. Specifically, the tunable automated song generation system 302 can train a melody prediction model from a song corpus. The tunable automated song generation system 302 can then apply the trained melody prediction model to lyric input received from the client 102 to automatically generate one or more melodies based on the lyric input.

The tunable automated song generation system 302 can receive values of tunable melody creation parameters from the client 102. The tunable automated song generation system 302 can then use the received values of tunable melody creation parameters to automatically generate one or more tuned melodies according to the values. Further, the tunable automated song generation system 302 can provide the automatically generated tuned melodies to the client 102, where the melodies can subsequently be reproduced and potentially be selected by the user. Accordingly, the tunable automated song generation system 302 can solve deficiencies of current rule-based songwriting systems in failing to provide mechanisms that allow users to actively collaborate with the systems in controlling automated songwriting by the systems. Specifically, the tunable automated song generation system 302 can provide functionalities to users for customizing automated songwriting according to their own personal preferences. As a result, greater diversity in automated songwriting can be achieved by the tunable automated song generation system 302 across different users.

Tunable melody creation parameters can include rhythm tuning parameters that can be used to adjust a rhythm of a generated melody, e.g. a melody automatically generated by the tunable automated song generation system 302 using lyrics. Specifically, a user can select an automatically generated melody, and new rhythms can be generated for the melody while keeping the same scale degrees in the melody by regenerating the rhythm. The tunable automated song generation system 302 can facilitate generation of a melody at varied rhythms by generating the melody at different rhythms. Specifically, a rhythm model included as part of a melody prediction model can be fed information about the melody including octave placement of notes in the melody, as discussed previously, and the lyrics that served as the basis for the melody. The rhythm model, as applied by the tunable automated song generation system 302, can then generate the melody at different rhythms based on the information about melody and the lyrics serving as the basis for the melody. In turn, the tunable automated song generation system 302 can provide the melody with varying rhythms to the client 102 where the melody can be reproduced to the user at the varying rhythms. The user can then provide values of tunable melody creation parameters indicating a selection of the melody at a specific rhythm of the varying rhythms. The tunable automated song generation system 302 can then return the melody at the selected rhythm to the client 102, where it can be used to generate a song. By providing the user with a melody at different rhythms, the tunable automated song generation system 302 can facilitate experimentation by the user in creating songs through automated song generation, e.g. by experimenting with different rhythms.

Further, tunable melody creation parameters can include rhythm restrictions or limits. Specifically, a user can provide rhythm restrictions, as values of tunable melody creation parameters, for possible rhythmic outcomes of automatically generated melodies. Rhythm restrictions can specify emitting or otherwise not creating notes with specific note durations. For example, rhythm restrictions can specify emitting whole notes or faster notes like a 32^{nd} note from an automatically generated melody. The tunable automated song generation system 302 can then apply the rhythm restrictions when generating one or more melodies to create one or more automatically generated melodies tuned according to the rhythm restrictions.

Additionally, tunable melody creation parameters can include scale degree tuning parameters that can be used to adjust scale degrees of a generated melody, e.g. a melody automatically generated by the tunable automated song generation system 302 using lyrics. Specifically, a user can select an automatically generated melody, and new scale degrees can be generated for the melody while keeping the same rhythm in the melody by adjusting scale degree tuning parameters. The tunable automated song generation system 302 can facilitate generation of a melody at varied scale degrees by generating the melody at different scale degrees. Specifically, a pitch model and an octave model included as part of a melody prediction model can be fed information about the melody including rhythm and note length in the melody and the lyrics that served as the basis for the melody. The pitch model and the octave model, as applied by the tunable automated song generation system 302, can then generate the melody at different scale degrees based on the information about melody and the lyrics serving as the basis for the melody. In turn, the tunable automated song generation system 302 can provide the melody with varying scale degrees to the client 102, where it can be reproduced to the user at the varying scaled degrees. The user can then provide values of tunable melody creation parameters indicating a selection of the melody at a specific scaled degree of the varying scale degrees. The tunable automated song generation system 302 can then return the melody at the selected scale degree to the client 102, where it can be used to generate a song. By providing the user with a melody at different scale degrees, the tunable automated song generation system 302 can further facilitate experimentation by the user in creating songs through automated song generation, e.g. by experimenting with different scale degrees.

Tunable melody creation parameters can also include melody count restrictions. Specifically a user can specify a number of different melodies to generate for given lyrics or a given set of lyrics. The tunable automated song generation system 302 can then generate a number of melodies for a given set of lyrics based on the melody count restrictions set by the user. For example, a user can set a number of melodies to create for a line of lyrics and the tunable automated song generation system 302 can generate a number of melodies for the line of lyrics based on the melody count set by the user.

Further, tunable melody creation parameters can include explore/exploit parameters. Explore/exploit parameters can control how heavily the tunable automated song generation system 302 relies on a melody prediction model to generate melodies for lyrics. Specifically, a melody prediction model can output a distribution over all possible outcomes for given scale degree/note durations. The explore/exploit parameter can define how many independent draws the tunable automated song generation system 302 makes from this overall distribution to generate one or more melodies. Specifically, the final resulting note selected for the one or more melodies can include the most common draw, with ties being broken by the original outcome distribution. For example, if scale degree 1 and 2 are tied after four draws, and the explore/exploit parameter is set to four draws, then the tunable automated song generation system 302 can then select the scale degree that was originally more likely in the distribution output by the model. Accordingly, a higher explore/exploit parameter value means the tunable automated song generation system 302 will typically exploit a distribution because the tunable automated song generation system 302 will almost always output the scale degree or duration that has the highest probability of occurring. Further, the explore/exploit parameter can allow the tunable automated song generation system 302 to favor the scale degrees and durations that are most likely, versus potentially taking a more varied approach and generating melodies that could be considered more experimental.

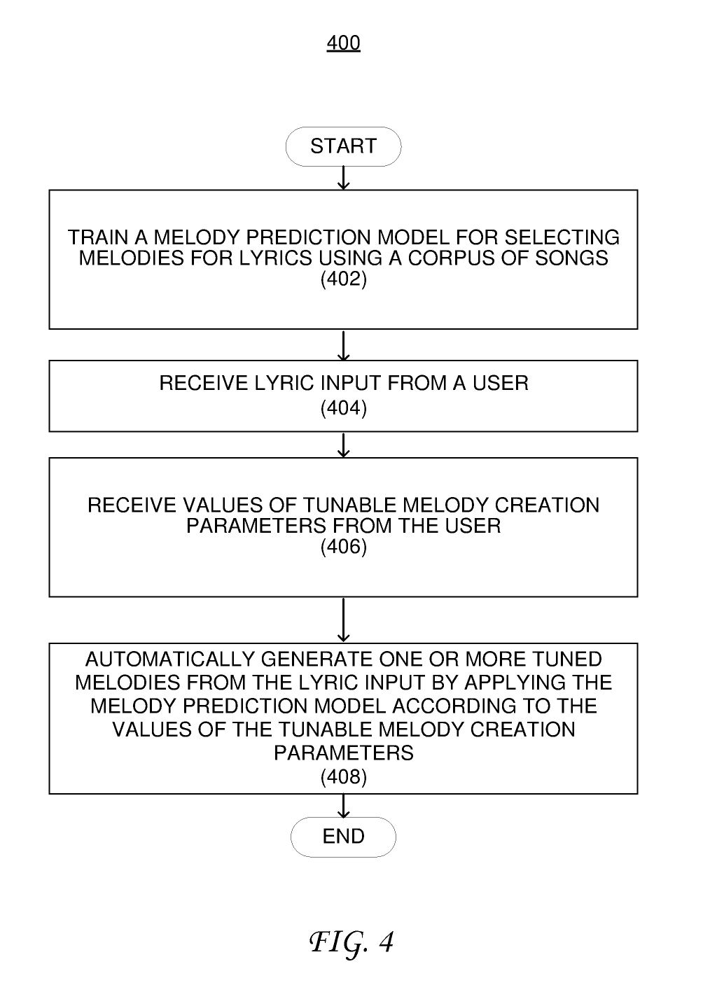

FIG. 4 illustrates steps of an example process 400 for automatically generating tuned melodies for a song based on lyrics. The process begins at step 402, where a melody prediction model for selecting models for lyrics is trained using a corpus of songs. The melody prediction model can be trained at step 402 using the various techniques and systems described herein. At step 404, lyric input is received from a user.

At step 406, values of tunable melody creation parameters are received from the user. The values of tunable melody creation parameters, received at step 406, can include one or a combination of values of rhythm tuning parameters, values of rhythm restriction parameters, values of scale degree tuning parameters, values of melody count restriction parameters, and values of explore/exploit parameters. For example, a value of tunable melody creation parameters received at step 406 can specify a number of times to draw an overall distribution of an output of the melody prediction model before selecting a melody feature for creating a melody based on lyrics.

At step 408, one or more tuned melodies are automatically generated from the lyric input by applying the melody prediction model according to the values of the tunable melody creation parameters. For example, values of scale degree tuning parameters can be used in applying the melody prediction model to generate the melodies at varying scale degrees according to the values of the scale degree tuning parameters. In another example, values of rhythm tuning parameters can be used in applying the melody prediction model to generate the melodies at varying rhythms according to values of the rhythm tuning parameters.

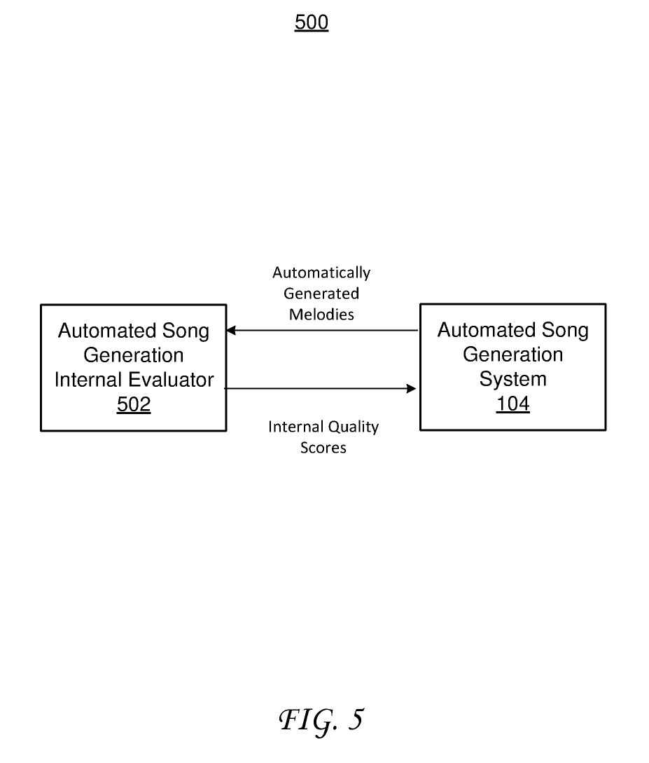

FIG. 5 illustrates an example of a system 500 for internally evaluating melodies automatically generated based on lyrics. The system 500 includes the automated song generation system 104 and an automated song generation internal evaluator 502. While the automated song generation system 104 is shown separate from the automated song generation internal evaluator 502, in various embodiments, the automated song generation internal evaluator 502 can be integrated as part of the automated song generation system 104. As discussed previously, the automated song generation system 104 functions to automatically generate melodies based on lyrics. Subsequently, the automated song generation system 104 can provide the automatically generated songs to the automated song generation internal evaluator 502.

The automated song generation internal evaluator 502 functions to internally evaluate automatically generated melodies received from the automated song generation system 104. Specifically, the automated song generation internal evaluator 502 can internally evaluate melodies that are automatically generated by the automated song generation system 104 based on lyrics. More specifically, the automated song generation internal evaluator 502 can internally evaluate melodies generated by the automated song generation system 104 based on lyrics before the melodies are provide to a user, e.g. through the client 102.

In internally evaluating automatically generated melodies, the automated song generation internal evaluator 502 can assign internal quality scores to the generated melodies. Further, the melodies can be sorted according to the internal quality scores and potentially reproduced for a user according to the internal quality scores. For example, melodies, e.g. melodies generated based on the same set of lyrics, with higher scores can be presented to the user before melodies, e.g. generated based on the same set of lyrics, with lower scores. This can allow a user to more efficiently explore a space of generated melodies. Specifically, a user can ask for a large number of melodies and only have to listen to a few of the top provided melodies to generate a song based on lyrics.

The automated song generation internal evaluator 502 can assign internal quality scores to melodies based on either or both sequence likelihood and an amount of note entropy across notes in a corresponding sequence of notes in the melodies. More specifically, the automated song generation internal evaluator 502 can assign internal quality scores according to the following equation.

$$score = {e}^{- seqLikelihood \frac{1}{length}} \cdot entropy \qquad Equation 1$$

In particular, balancing the likelihood of the sequence by its entropy is important because some genres on which the models can be trained, such as pop, contain highly repetitive sequences of notes. Although consecutive occurrences of the same note may work well as part of complete compositions, presenting such melodies is counterproductive. Even the most amateur songwriter can set lyrics to the same repeated note. Adding an entropy term leads to lower scores for highly repetitive options, allowing more varied ones to appear towards the top of the list of suggestions. Accordingly, equation 1 can give lower rankings to sequences of repeated notes, and higher ranking to melodic, novel sequences. In turn, this can help to ensure diversity in methods that are presented and subsequently selected across different users.

Seqlikelhood in equation 1 (herein referred to as “sequence likelihood”) can include a likelihood that a melody prediction model would select a specific sequence of octaves, rhythms, and/or scale degrees in selecting a melody based on lyrics. Length, as shown in equation 1, includes a length of notes in a melody that a quality score is created for using equation 1. Entropy in equation 1 can include the entropy across notes in corresponding sequences of notes in melodies generated based on lyrics using a melody prediction model. Specifically, entropy can be calculated by the number of unique scale-degrees occurring in a melody, normalized by the number of (non-accidental) degrees in a scale. In equation 1, the sequence likelihood is not multiplied directly by corresponding entropy. This is because sequence likelihood is highly sensitive to sequence length, as longer sequences are inherently less likely. The first factor in equation 1 normalizes the sequence likelihood, yielding a value between 0 and 1. Note that length denotes the number of notes in the melody. Therefore, the automated song generation internal evaluator 502 can assign internal quality scores based on both sequence likelihood and entropy by effectively balancing the sequence likelihood and the entropy.

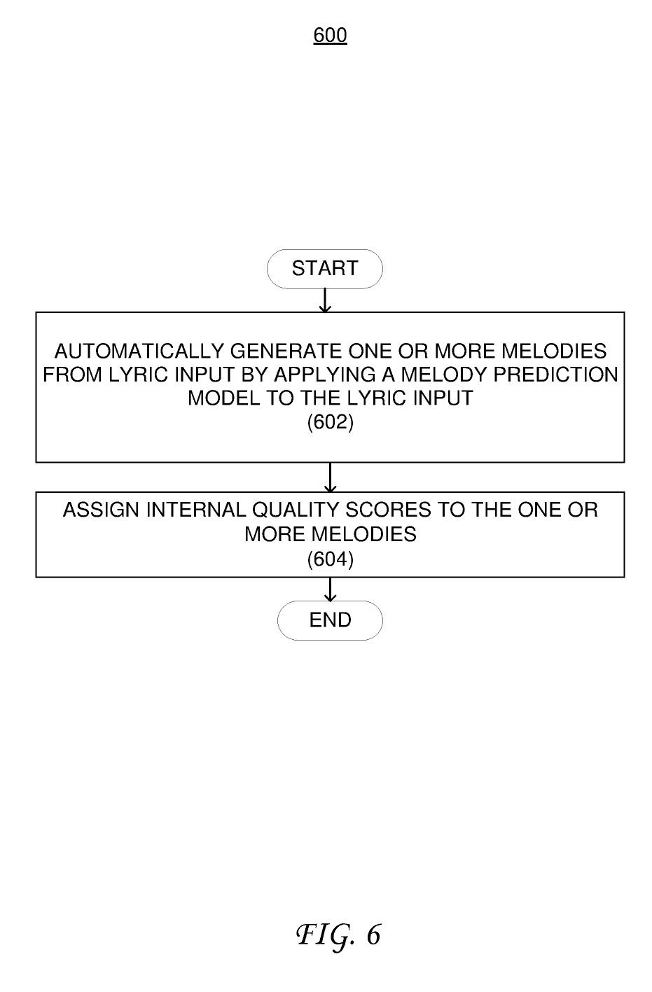

FIG. 6 illustrates steps of an example process 600 for assigning internal quality scores to melodies automatically generated based on lyrics. The process begins at step 602, where one or more melodies are automatically generated from lyric input by applying a melody prediction model to the lyric input. The melodies can be tuned melodies created from lyric input by applying a melody prediction model to the lyric input according to values of one or more tunable melody creation parameters.

At step 604, internal quality scores are assigned to the one or more melodies. Internal quality scores can be assigned based on either or both sequence likelihoods that a melody prediction model would select a specific sequence for a generated melody and entropy included in a sequence of a generated melody. The melodies can be reproduced to a user according to internal quality scores assigned to the melodies. For example, melodies can be presented to a user in descending order based on corresponding quality scores assigned to the melodies. This can ensure that a user is first presented with quality melodies and reduce the number of melodies that the user has to sift through before finding a desired melody for a song.

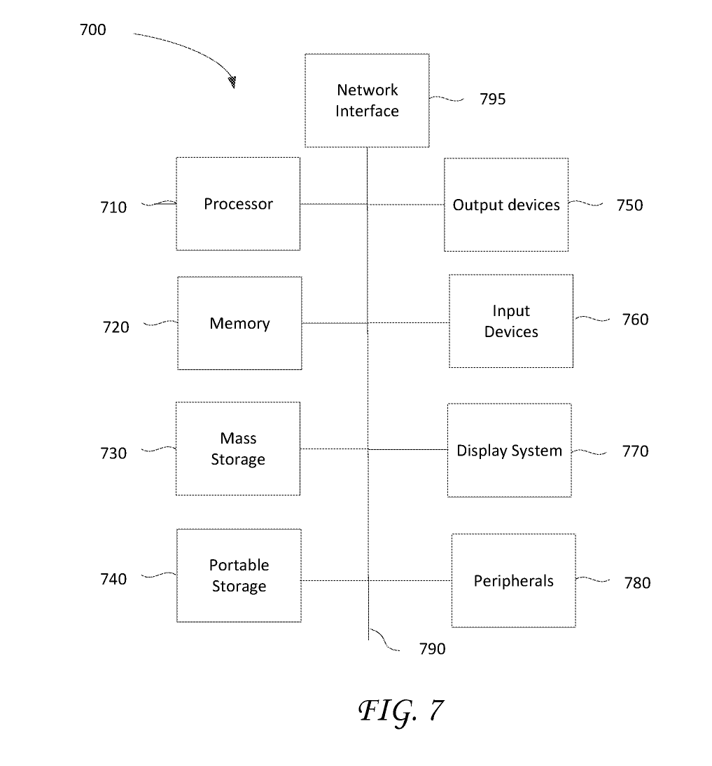

FIG. 7 illustrates a computing system that may be used to implement an embodiment of the present invention. The computing system 700 of FIG. 7 includes one or more processors 710 and main memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, peripheral devices 780, and network interface 795.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 810. Mass storage device 730 can store the system software for implementing embodiments of the present invention for purposes of loading that software into main memory 820.

Portable storage device 740 operates in conjunction with a portable non-volatile storage medium, such as a FLASH memory, compact disk or Digital video disc, to input and output data and code to and from the computer system 700 of FIG. 7. The system software for implementing embodiments of the present invention may be stored on such a portable medium and input to the computer system 700 via the portable storage device 840.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD), a plasma display, an organic light-emitting diode (OLED) display, an electronic ink display, a projector-based display, a holographic display, or another suitable display device. Display system 870 receives textual and graphical information, and processes the information for output to the display device. The display system 770 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 780 may include any type of computer support device to add additional functionality to the computer system. For example, peripheral device(s) 780 may include a modem or a router.

Network interface 795 may include any form of computer interface of a computer, whether that be a wired network or a wireless interface. As such, network interface 795 may be an Ethernet network interface, a BlueTooth™ wireless interface, an 802.11 interface, or a cellular phone interface.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 700 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, FLASH memory, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

It is understood that any specific order or hierarchy of steps in the processes disclosed is an illustration of exemplary approaches. Based upon design preferences, it is understood that the specific order or hierarchy of steps in the processes may be rearranged, or that only a portion of the illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A system for providing automated songwriting, the system comprising:
one or more processors; and
a non-transitory memory coupled to the one or more processors, the memory comprising instructions stored therein, which when executed by the processors, cause the processors to perform operations comprising:
training a melody prediction model for selecting melodies for lyrics using a corpus of songs, the melody prediction model including modeled melody features and corresponding modeled lyric features;
receiving lyric input of lyrics including lyric features from a user;
applying the melody prediction model to the lyric input to automatically generate one or more melodies for the lyric input by generating probability distributions of melody features based on the lyric features in the lyrics input using the melody prediction model and selecting melody features from the probability distributions of melody features to form the one or more melodies; and
providing the one or more melodies to the user to generate a song using the lyrics.

2. The system of claim 1, wherein the melody prediction model includes a combination of an octave model including modeled octave features, a pitch model including modeled pitch features, and a rhythm model including modeled rhythm features, and the one or more processors are further configured for performing operations comprising: applying the octave model to the lyric input to generate the one or more melodies;
applying the rhythm model to the lyric input to generate the one or more melodies based on applying the octave model to the lyric input; and
applying the pitch model to the lyric input to generate the one or more melodies based on applying the octave model and the rhythm model to the lyric input.

3. The system of claim 1, wherein the melody prediction model includes a rhythm model and an interval model and the one or more processors are further configured for performing operations comprising:
applying the interval model to the lyric input to generate the one or more melodies; and
applying the rhythm model to the lyric input to generate the one or more melodies based on applying the interval model to the lyric input.

4. The system of claim 1, wherein the corpus of songs are songs within a specific style of music and the one or more processors are further configured for performing operations comprising:
training the melody prediction model for selecting the melodies for the lyrics from the corpus of songs using a language model of a specific language.

5. The system of claim 1, wherein the one or more processors are further configured for performing operations comprising:
receiving, from the user, input indicating values of one or more tunable melody creation parameters for customizing automatic generation of a melody; and
applying the melody prediction model to the lyric input according to the values of the one or more tunable melody creation parameters to automatically generate the one or more melodies based on the lyric input for the user.

6. The system of claim 1, wherein the one or more melodies include a plurality of melodies and the one or more processors are further configured for operations further comprising:
assigning corresponding internal quality scores to the plurality of melodies, wherein the corresponding internal quality scores are assigned to the plurality of melodies based on both a sequence likelihood of corresponding sequences of notes of the plurality of melodies and an amount of note entropy across notes in the corresponding sequences of notes of the plurality of melodies; and
reproducing the plurality of melodies to the user based on the corresponding internal quality scores assigned to the plurality of melodies.

7. The system of claim 1, wherein the one or more processors are further configured for performing operations comprising:
receiving, from the user, additional lyric input of additional lyrics for the song;
applying the melody prediction model to the additional lyric input to automatically generate one or more additional melodies for the additional lyric input; and
providing the one or more additional melodies for the additional lyric input to the user to generate the song using the lyrics, the additional lyrics, and the one or more melodies automatically generated for the lyrics.

8. The system of claim 7, wherein the one or more processors are further configured for performing operations comprising:
receiving, from the user, an indication of a selected melody of the one or more melodies provided to generate the song using the lyrics; and
automatically generating the one or more melodies for the additional lyric input based on the selected melody.

9. The system of claim 1, wherein the one or more processors are further configured for performing operations comprising:
adding the song to the corpus of songs created by the user with the one or more melodies; and
updating the melody prediction model based on the song added to the corpus of songs.

10. A method for providing automated songwriting, the method comprising:
training a melody prediction model for selecting melodies for lyrics using a corpus of songs, the melody prediction model including modeled melody features and corresponding modeled lyric features;
receiving lyric input of lyrics including lyric features from a user;
applying the melody prediction model to the lyric input to automatically generate one or more melodies for the lyric input by generating probability distributions of melody features based on the lyric features in the lyrics input using the melody prediction model and selecting melody features from the probability distributions of melody features to form the one or more melodies; and
providing the one or more melodies to the user to generate a song using the lyrics.

11. The method of claim 10, wherein the melody prediction model includes a combination of an octave model including modeled octave features, a pitch model including modeled pitch features, and a rhythm model including modeled rhythm features, the method further comprising:
applying the octave model to the lyric input to generate the one or more melodies;
applying the rhythm model to the lyric input to generate the one or more melodies based on applying the octave model to the lyric input; and
applying the pitch model to the lyric input to generate the one or more melodies based on applying the octave model and the rhythm model to the lyric input.

12. The method of claim 10, further comprising:
receiving, from the user, input indicating values of one or more tunable melody creation parameters for customizing automatic generation of a melody; and
applying the melody prediction model to the lyric input according to the values of the one or more tunable melody creation parameters to automatically generate the one or more melodies based on the lyric input for the user.

13. The method of claim 10, wherein the one or more melodies include a plurality of melodies, the method further comprising:
assigning corresponding internal quality scores to the plurality of melodies, wherein the corresponding internal quality scores are assigned to the plurality of melodies based on both a sequence likelihood of corresponding sequences of notes of the plurality of melodies and an amount of note entropy across notes in the corresponding sequences of notes of the plurality of melodies; and
reproducing the plurality of melodies to the user based on the corresponding internal quality scores assigned to the plurality of melodies.

14. The method of claim 10, further comprising:
receiving, from the user, additional lyric input of additional lyrics for the song;
applying the melody prediction model to the additional lyric input to automatically generate one or more additional melodies for the additional lyric input; and
providing the one or more additional melodies for the additional lyric input to the user to generate the song using the lyrics, the additional lyrics, and the one or more melodies automatically generated for the lyrics.

15. The method of claim 14, further comprising:
receiving, from the user, an indication of a selected melody of the one or more melodies provided to generate the song using the lyrics; and
automatically generating the one or more melodies for the additional lyric input based on the selected melody.

16. A non-transitory computer-readable storage medium, having embodied thereon a program executable by one or more processors to perform operations comprising:
training a melody prediction model for selecting melodies for lyrics using a corpus of songs, the melody prediction model including modeled melody features and corresponding modeled lyric features;
receiving lyric input of lyrics including lyric features from a user;
applying the melody prediction model to the lyric input to automatically generate one or more melodies for the lyric input by generating probability distributions of melody features based on the lyric features in the lyrics input using the melody prediction model and selecting melody features from the probability distributions of melody features to form the one or more melodies; and
providing the one or more melodies to the user to generate a song using the lyrics.

17. The non-transitory computer-readable storage medium, of claim 16, wherein the melody prediction model includes a combination of an octave model including modeled octave features, a pitch model including modeled pitch features, and a rhythm model including modeled rhythm features, and the one or more processors are further configured for performing operations comprising:
applying the octave model to the lyric input to generate the one or more melodies;
applying the rhythm model to the lyric input to generate the one or more melodies based on applying the octave model to the lyric input; and
applying the pitch model to the lyric input to generate the one or more melodies based on applying the octave model and the rhythm model to the lyric input.

18. The non-transitory computer-readable storage medium of claim 16, wherein the one or more processors are further configured for performing operations comprising:
receiving, from the user, input indicating values of one or more tunable melody creation parameters for customizing automatic generation of a melody; and
applying the melody prediction model to the lyric input according to the values of the one or more tunable melody creation parameters to automatically generate the one or more melodies based on the lyric input for the user.

19. The non-transitory computer-readable storage medium of claim 16, wherein the one or more melodies include a plurality of melodies and the one or more processors are further configured for performing operations comprising:
assigning corresponding internal quality scores to the plurality of melodies, wherein the corresponding internal quality scores are assigned to the plurality of melodies based on both a sequence likelihood of corresponding sequences of notes of the plurality of melodies and an amount of note entropy across notes in the corresponding sequences of notes of the plurality of melodies; and
reproducing the plurality of melodies to the user based on the corresponding internal quality scores assigned to the plurality of melodies.

20. The non-transitory computer-readable storage medium of claim 16, wherein the one or more processors are further configured for performing operations comprising:
receiving, from the user, additional lyric input of additional lyrics for the song;
applying the melody prediction model to the additional lyric input to automatically generate one or more additional melodies for the additional lyric input; and
providing the one or more additional melodies for the additional lyric input to the user to generate the song using the lyrics, the additional lyrics, and the one or more melodies automatically generated for the lyrics.
